(19) United States
(12) Patent Application Publication
(10) Pub. No.: US 2005/0211108 A1
(43) Pub. Date: Sep. 29, 2005

(54) Method and device for automatically regulating a quantity of product deposited

(76) Inventor: Philippe Carabin, St Sebastien-Sur-Loire (FR)

Correspondence Address: YOUNG & THOMPSON, 745 SOUTH 23RD STREET, 2ND FLOOR, ARLINGTON, VA, 22202, US

(21) Appl. No.: 10/511,845

(22) PCT Filed: Apr. 18, 2003
(86) PCT No.: PCT/FR03/01264

§ 371 Date: May 13, 2005

(30) Foreign Application Priority Data
Apr. 19, 2002 (FR) 02/04957

(51) Int. Cl. A01J 11/00

(52) U.S. Cl. 99/468

(57) ABSTRACT

A method for automatic regulation of a quantity of product deposited in a repetitive fashion by a deposition actuator (1), which deposition actuator (1) is associated with adjustment elements (2) for adjusting the quantity of product deposited, includes:
automatically determining, notably by a system of cameras (10) associated with calculation elements (12), the quantity of product effectively deposited by the deposition actuator during the deposition operation,
automatically comparing by electronic/computerized elements (7) the quantity of product effectively deposited with the desired quantity of product to be deposited and,
in case of difference between both values, automatically re-adjusting the quantity of product deposited during subsequent deposition operations, by acting upon the adjustment elements (2). The invention also relates to the device for implementing the method and the deposition installation integrating such a device.

The present invention relates to a method and a device for automatic regulation of a quantity of product deposited in a repetitive fashion by a deposition actuator; it also relates to the deposition installation fitted with such a device.

This invention relates in particular to the industrial fields of the production of biscuits and chocolates wherein the successive operations of automatic deposition of liquid, semi-liquid or pasty product (such as cream, jam or chocolate) on a receiving support, notably in the form of a biscuit, are performed.

Conventionally, to be sure of depositing successions of minimum quantities on or in a receiving support, and thus in spite of the different perturbations or possible evolutions notably associated with the depositing conditions and the possibly fouling of the depositing actuator, the quantity of product deposited on said receiving support is increased, in particular relative to the experience acquired. Moreover, punctual measurements of verification are conducted regularly by an operator, followed, if necessary, by corrective manual adjustment.

However, the corresponding operations of verification are still not very easy to implement. On the other hand; the overdose performed may prove relatively costly, in particular when handling larges quantities of product.

There is also known by the document EP-A-1 132 722 a system which enables to correct the quantity of product delivered repetitively by an actuator or a deposition valve. But it is provided here to perform the correction in question, directly, by measuring the flow rate of the product just before deposition, which is very complicated and costly to implement. This technology may hardly be used, on the other hand, for small quantities of deposition.

The purpose of the present invention is to remedy these shortcomings by performing, in a simple fashion, regular and entirely automated operations of control and self-regulation of the quantity of matter deposited by the deposition actuator.

In this view, the method according to the present invention for automatic regulation of the quantity of product deposited in a repetitive fashion by a deposition actuator, which actuator is associated with means which enable to adjust the quantity of product deposited, consists:
in determining automatically the quantity of product effectively deposited by the deposition actuator during the deposition operation,
in comparing automatically this quantity of product effectively deposited with the desired quantity of product to be deposited, and
in case of difference between both values, in re-adjusting automatically the quantity of product deposited during subsequent deposition operations by acting upon said means of adjustment.

Preferably, the quantity of product effectively deposited is determined by a measurement of volume.

This measurement of volume may be realised after obtaining a record of the deposition relief of product. In certain particular cases, it may be realised after obtaining a record of the support of product on its own, to form a reference, followed by a record of the relief of the product support/product deposition assembly.

The device for implementing the method comprises:
at least one deposition actuator of the product,
means which enable to adjust the quantity of product deposited by said actuator,
means to determine the quantity of product deposited by said actuator,
means to compare the quantity of product deposited with the quantity of product to be deposited, and
means which enable to act upon said means of adjustment of the actuator, to re-adjust automatically the quantity of product deposited during subsequent deposition operations, in case of difference noticed between the quantity of product effectively deposited and the desired quantity to be deposited.

According to a preferred embodiment, the means to determine the quantity of product effectively deposited are composed of means for measuring the volume of this quantity deposited.

According to a first embodiment, these measuring means comprise:
means for recording directly the deposition relief of product, and
a data processing module to define said volume.

According to another possible embodiment, the means of volume measurement comprise:
means to record the relief of the product support/product deposition assembly,
means to record the contour of the product support on its own, and
a data processing module to define said volume.

The means to record the deposition contour of product are advantageously composed of at least two cameras.

Preferably, additional means are provided to put in evidence the relief to be recorded.

These particular means consist advantageously of a laser beam system, either mobile, or fixed, associated with means enabling to generate a set of scores or a square ruling on the surface of the product and/or of its support.

The invention also relates the product deposition installation fitted with at least one self-regulation device as defined above.

According to a preferred embodiment, this installation comprises:
a plurality of deposition actuators provided above a conveyor system to realise deposition rows of product, either directly on said conveyor system, or on reception supports placed on said conveyor system, and
means to record the deposition relief of product, arranged on a mobile cart perpendicular to the feeding direction of said conveyor system in order to record the corresponding relief on the different lines formed.

But the invention will be further illustrated, without being limited thereto, by the following description associated with the appended drawings wherein:

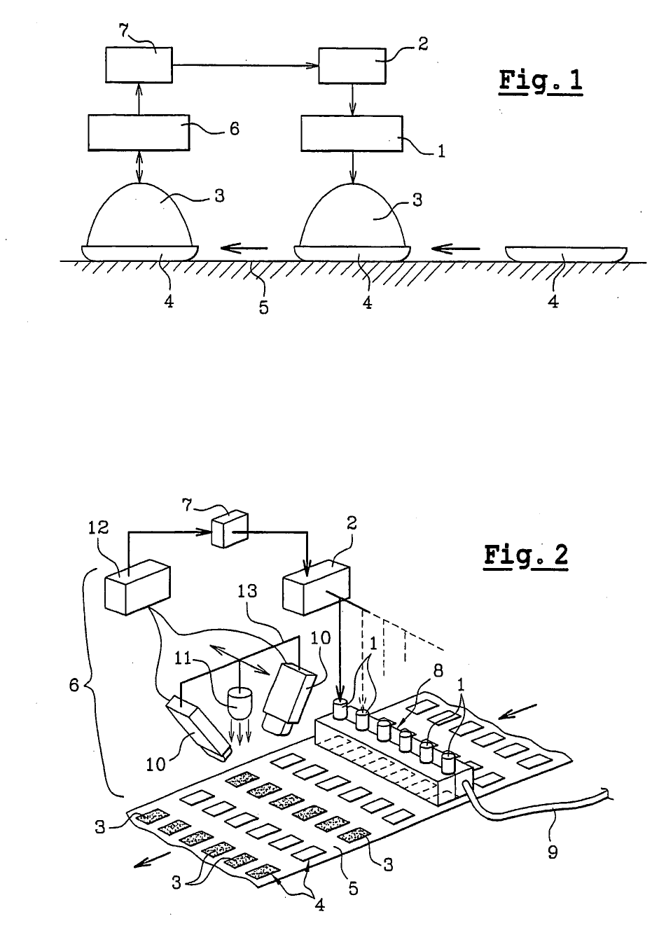

FIG. 1 illustrates, in the form of block diagram, the method and the self-regulation device according to the present invention;

FIG. 2 is a schematic view which shows a deposition installation of cream or of chocolate on biscuits, fitted with a self-regulation device according to the present invention;

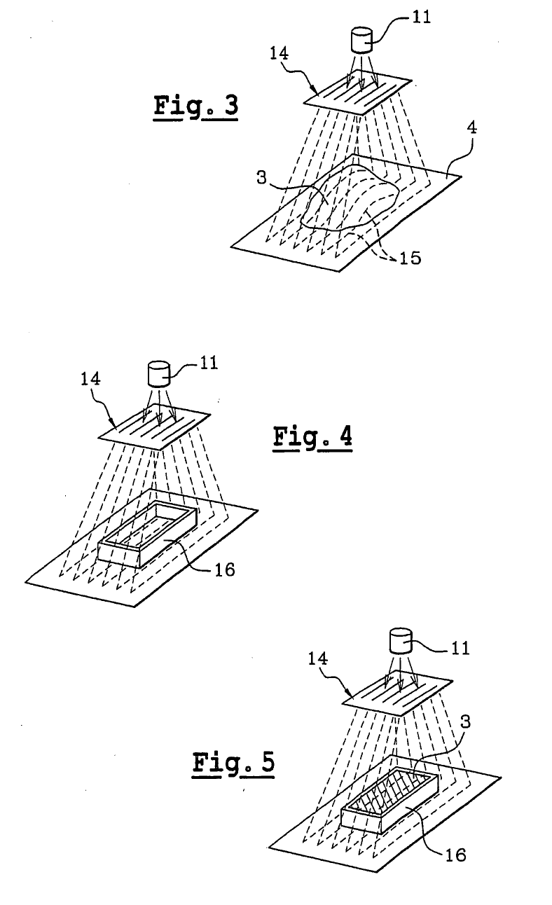

FIG. 3 illustrates a possible embodiment of the technique which enables to put in evidence the relief or the cortours of the product deposited, in order to determine the volume of the deposition of product;

FIGS. 4 and 5 illustrate the principle of determination of the volume of the deposition of product, using means to record the relief of the product support on its own and means to record the relief of both the product support/deposited product.

The schematic representation of FIG. 1 illustrates an actuator 1, associated with means of adjustment 2, which deposits a quantity of product 3 repetitively in or on supports 4 carried by a conveyor system 5.

After deposition, suitable means 6 enable to define the quantity of product 3 effectively deposited by the actuator; this quantity of product effectively deposited is compared by an electronic/computerised managing unit 7 with the desired quantity of product to be deposited on or in the supports 4; and in case of difference between both values, said managing unit 7 controls the means of adjustment 2 of the deposition actuator 1 to re-adjust automatically the quantity of product which will be deposited on the subsequent supports.

The measurement of the quantity of product effectively deposited and the possible correction of adjustment may be carried out at each deposition or only according to a preset periodicity.

The deposition actuator 1 may be in the form of a slide valve, needle valve, screw valve, diaphragm valve, mufti-nozzle rotary valve (slide-type) or other.

The associated means of adjustment 2 depend on the type of actuator used; they may be means for adjusting the opening time of the valve within the framework notably of the slide or needle valves, or the number of turns of the screws within the framework of a screw valve. These means of adjustment 2 may be integrated to said actuator or are integral with the managing unit 7, as the case may be.

Preferably, the quantity of product deposited on or in the receiving support is determined by a volumetric measurement; and this measurement of volume is obtained by any appropriate means, for instance using a wave transmission and reception system, or by an optical path.

In all cases, the raw data receiving means are associated with an appropriate processing and calculation module; this module may be integrated to the data receiving means, or to the managing unit 7.

This managing unit 7 is advantageously in the form of a programmable automaton or a micro-computer.

Preferably, the means for measuring the quantity of product deposited comprise optical means to record the relief, either of the deposition of product on its own, or of the support of product on its own, then the product supportiproduct deposition assembly. These relief records are then processed by the processing and calculation module to define the volume of product expected.

These recording means are advantageously associated with a system for putting the relief in evidence.

FIG. 2 is a schematic representation of a device according to the present invention integrated to an installation for depositing cream or chocolate on biscuits.

On this FIG. 2, it should be noted that the conveyor system 5 carries six lines of biscuits 4 forming the supports receiving the cream or the chocolate 3.

Each line of biscuits 4 includes its own deposition actuator 1; and the series of the six actuators forms a deposition line 8 which extends transversally to the progress direction of the conveyor 5, fed with product to be deposited by a single tubing 9.

In the case illustrated, only a biscuit on two of each line receives the cream or the chocolate 3; the biscuit which does not receive any product is intended subsequently in the manufacturing process to cover the loaded biscuit, to form a stuffed-snack type food product.

Just downstream of the deposition line 8, one should note the presence of the device 6 for measuring the quantity of product deposited. This measuring device 6 is composed of a couple of cameras 10, an optical source 11 enabling to put in evidence the external envelope of the product 3 deposited on the biscuit, and a module 12 for processing the signal.

The optical source 11 is preferably in the form of a laser. This laser source may be either mobile, adapted for scanning the whole surface of the product deposited, or associated with particular means enabling to generate a set of scores or a square ruling on the surface of the product deposited.

Both cameras 10 are judiciously arranged to record the lines of projection formed by the laser source, and the signal processing module processes the recorded date to define the volume of product deposited, by integrating the different profiles recorded.

As aforementioned, this measurement of volume, transformed possibly into a weight value, is then compared by the managing unit 7 with the quantity of matter to be deposited on the biscuits, and a possible correction operation is realised on the means of adjustment 2 to obtain the self-regulation expected.

In practice, a correction or a re-adjustment of the settings will be carried out exclusively in case when the difference between the measured value and the expected value exceeds a preset tolerance threshold corresponding for instance at least to the manufacturing tolerances of the products.

It should be noted that, if necessary, more than two cameras 10 may be used for recording the curves of level put in evidence by the laser source.

Within the framework of an installation as illustrated on FIG. 2, processing several files juxtaposed, the system of cameras 10 and of laser source 11 is mounted on a cart, referred schematically as 13, mobile in translation perpendicular to the feeding direction of the conveyor system 5. Consequently, the deposition actuators 1 of each line may be tested and possibly corrected after one another.

If needed, the assembly of cameras 10/laser source 11 may be integrated in a suitable cowling, in particular to avoid any disturbance by the ambient light; the corresponding shrouded cabinet may integrate lighting means suited to optimise the recording of the curves of level by the system of cameras.

This type of installation enables to conduct very frequent automatic measurements on each of the lines processed in order to correct almost instantly the possible drifts of the quantities of matter deposited.

FIG. 3 represents a laser source 11 fitted with known means schematised by a ruling 14 enabling the generation of curves of level 15 on the product 3 deposited.

These curves of level 15 are recorded by the system of cameras and enable by integration calculation to know the volume of product deposited.

The support 4 of the product 3 serves here as a plane of reference for this calculation; it may be a particular flat support, such as a biscuit for instance, or directly of the feeding conveyor, notably when depositing chocolate on said conveyor, for the manufacture of [symbol] chocolate whirls [symbol] .

FIGS. 4 and 5 illustrate the measuring principle which consists in determining in a first step the relief of the product support on its own, then in a second step the relief of both the product support/deposited product, in order to determine the difference the quantity of product deposited.

To do so, a first camera 10/laser source 11 measuring assembly is provided upstream of the depositing actuator, and a second identical or similar assembly is placed downstream of said actuator.

FIG. 4 illustrates the determination principle of the contour of the product support on its own, here represented in the form of a small tart 16, using curves of level generated by the laser source 11.

FIG. 5 illustrates the determination principal of the contour of the support 16 loaded with product 3.

The signal processing module integrates the values from both records to calculate, by using the difference, the quantity of product 3 deposited in the small tart 16. This measuring principle may be for instance used for non-homogeneous supports on the same line, or for hollow supports, such as small tart bases or other.

1. A method for automatic regulation of a quantity of product deposited in a repetitive fashion by a deposition actuator (1), which deposition actuator (1) is associated with means (2) which enable to adjust the quantity of product deposited, characterised in that it consists:
in determining automatically the quantity of product effectively deposited by the deposition actuator (1) during the deposition operation,
in comparing automatically this quantity of product effectively deposited with the desired quantity of product to be deposited, and
in case of difference between both values, in re-adjusting automatically the quantity of product deposited during subsequent deposition operations by acting upon said means of adjustment (2).

2. A method according to claim 1, characterized in that it consists in determining the quantity of product effectively deposited by the deposition actuator (1) by measuring the volume of this quantity deposited.

3. A method according to claim 2, characterized in that it consists in determining the quantity of product effectively deposited by the deposition actuator (1) by measuring the volume of this quantity deposited, after obtaining a record of the deposition relief of product.

4. A method according to claim 2, characterized in that it consists in determining the quantity of product effectively deposited by the deposition actuator (1) by measuring the volume of this quantity deposited, after—obtaining a record of the deposition relief of product on its own, to form a reference, and—a record of the relief of both the product support/deposited product.

5. A device for implementing the method according to claim 1, characterized in that it includes:
at least one deposition actuator (1) of the product,
means (2) which enable to adjust the quantity of product deposited by said actuator (1),
means (6) to determine the quantity of product deposited by said actuator (1),
means (7) to compare the quantity of product deposited with the desired quantity of product to be deposited, and
means (7) which enable to act upon said means of adjustment (2) of the actuator (1), to re-adjust automatically the quantity of product deposited during subsequent deposition operations, in case of difference noticed between the quantity of product effectively deposited and the desired quantity of product to be deposited.

6. A device according to claim 5, characterized in that the means (6) to determine the quantity of product effectively deposited are composed of means for measuring the volume of this quantity deposited.

7. A device according to claim 6, characterized in that the means (6) for measuring the volume of the quantity of product deposited comprise:
means (10,11) to record the deposition relief of product, and
a data processing module (12) to define said volume.

8. A device according to claim 6, characterized in that the means (6) for measuring the volume of the quantity of product deposited comprise—means to record the relief of both the product support/deposited product,—means to record the relief of the product support on its own, and—a data processing module to define said volume.

9. A device according to claim 7, characterized in that the relief recording means consist of at least two cameras (10).

10. A device according to claim 9, characterized in that it includes additional means (11) to put in evidence the relief to be recorded.

11. A device according to claim 10, characterized in that the means for putting the relief in evidence consist of a laser beam system (11).

12. A device according to claim 11, characterized in that it includes a mobile laser beam system.

13. A device according to claim 11, characterized in that it includes a fixed laser beam system (11) associated with means (14) enabling to generate a set of scores or a square ruling on the surface of the product (3) and/or of its support (4,16).

14. A product deposition installation including at least one device according to claim 5.

15. A product deposition installation according to claim 14, characterized in that it includes—a plurality of deposition actuators (1) provided above a conveyor system (5) to form product deposition rows directly on said conveyor system (5) or on reception supports (4,16) placed on said conveyor system (5), and—means (10,11) to record the deposition relief of product (3), arranged on a mobile cart (13) perpendicular to the feeding direction of said conveyor system (5) in order to record the deposition relief of product on the different lines formed.

16. A device according to claim 8, characterized in that the relief recording means consist of at least two cameras (10).
